(19) United States
(12) Patent Application Publication
(10) Pub. No.: US 2009/0112941 A1
(43) Pub. Date: Apr. 30, 2009

(54) COMPUTER SYSTEM AND FIRMWARE RECOVERY METHOD FOR COMPUTER SYSTEM

(75) Inventors: Nan-Kun Lo, Taipei (TW); Chiy-Ferng Perng, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/190,595

(22) Filed: Aug. 13, 2008

(30) Foreign Application Priority Data
Oct. 31, 2007 (TW) 96141063

(51) Int. Cl. G06F 17/30

(52) U.S. Cl. 707/202; 707/E17.007

(57) ABSTRACT

A firmware recovery method for a computer system including the following steps is provided. The computer system enters a firmware recovery mode. It is determined whether a display unit initial firmware is stored in a non-volatile memory. While the display unit initial firmware is not completely stored in the non-volatile memory, the display unit initial firmware is read from a storage apparatus for initializing a display unit. The display unit displays a firmware recovery hint. A complete initial firmware is read from the storage apparatus and then stored to the non-volatile memory. Finally, the computer system is turned on again.

### CROSS-REFERENCE TO RELATED APPLICATION

This application claims the priority benefit of Taiwan application serial no. 96141063, filed on Oct. 31, 2007. The entirety of the above-mentioned patent application is hereby incorporated by reference herein and made a part of specification.

### BACKGROUND OF THE INVENTION

1. Field of the Invention

The present invention generally relates to a computer system and a firmware recovery method for the computer system.

2. Description of Related Art

With the advance of technology, existing computer system manufacturers continuously provide users with new firmware versions, so as to enable the users to update the firmware by themselves for improving computer system performance or supporting more new peripheral equipments. When a user updates firmware by himself/herself, the firmware on a motherboard must perform read/write operation on a flash memory on the motherboard. Nevertheless, the firmware recovery is required first once the update fails due to external factors such as improper operations or power off.

The flash memory is still required during the firmware recovery, but the flash memory is damaged when the update fails and may lose most data, and only data within a read only memory (ROM) portion in the flash memory is not affected. A display unit (card) initial firmware stored in the flash memory and occupying a large memory space often cannot be configured in the ROM. Therefore, when the firmware recovery is performed, no display unit initial firmware or no complete display card initial firmware can be found since the flash memory is damaged when the update fails. Therefore, the computer system cannot initialize the display unit due to the lack of the display unit initial firmware when recovering the firmware, and thus the user also cannot recover or update the firmware according to a firmware recovery hint displayed on a display apparatus controlled by the display unit. In this case, the user has no choice but to send the whole computer system back to a manufacturer for maintenance, which results in great inconvenience.

### SUMMARY OF THE INVENTION

Accordingly, the present invention is directed to a firmware recovery method for computer system, which enables a user to finish a firmware recovery work by himself/herself, so as to avoid inconvenience of having to send the computer system back to a manufacturer for maintenance.

The present invention is also directed to a computer system, which enables a user to recover firmware by himself/herself without sending the computer system back to a manufacturer for maintenance.

The present invention provides a firmware recovery method for computer system, which includes the following steps. The computer system enters a firmware recovery mode. It is determined whether a display unit initial firmware is stored in a non-volatile memory. While the display unit initial firmware is not completely stored in the non-volatile memory, the display unit initial firmware is read from a storage apparatus for initializing a display unit. A firmware recovery hint is displayed on the display unit. A complete initial firmware is read from the storage apparatus and then stored into the non-volatile memory. Finally, the computer system is turned on again.

The firmware recovery method for computer system according to the present invention further includes reading the display unit initial firmware from the non-volatile memory and then initializing the display unit while the display unit initial firmware is stored in the non-volatile memory.

In the firmware recovery method for computer system, the step of reading the display unit initial firmware from the storage apparatus includes reading a storage medium in the storage apparatus.

In the firmware recovery method for computer system, the step of reading the display unit initial firmware from the storage apparatus includes reading from a hard disk drive, a floppy drive, an optical disk drive, or a universal serial bus (USB) apparatus.

In the firmware recovery method for computer system, the process of reading the complete initial firmware and then storing the complete initial firmware into the non-volatile memory includes the following steps. The complete initial firmware is read from the storage apparatus and then stored into a volatile memory. Then, the complete initial firmware stored in the volatile memory is stored into the non-volatile memory.

In the firmware recovery method for computer system, the step of entering the firmware recovery mode includes entering the firmware recovery mode only after determining that the complete initial firmware is not stored in the non-volatile memory.

In the firmware recovery method for computer system, the step of reading the complete initial firmware from the storage apparatus includes setting by a user according to the firmware recovery hint so as to read the complete initial firmware from the storage apparatus.

The present invention provides a computer system, which includes a chipset, as well as a display unit, a non-volatile memory, a storage apparatus, and a central processing unit (CPU) respectively coupled to the chipset. While the CPU determines that a complete initial firmware of the computer system is not stored in the non-volatile memory, the CPU enters a firmware recovery mode. While a display unit initial firmware is not completely stored in the non-volatile memory, the display unit initial firmware is read from the storage apparatus and then the display unit is initialized. A firmware recovery hint is displayed on the display unit. The complete initial firmware of the storage apparatus is stored into the non-volatile memory. Then, the computer system is turned on again.

In the computer system, the chipset includes a north bridge chip and a south bridge chip. The north bridge chip is coupled to the CPU and the display unit. The south bridge chip is coupled to the north bridge chip, the non-volatile memory, and the storage apparatus.

In the computer system, the display unit is a video graph array (VGA) display unit.

In the computer system, the non-volatile memory is a flash memory.

In the computer system, the non-volatile memory is composed of an electrically erasable memory and a read only memory.

In the computer system, the storage apparatus is any one selected from among a hard disk drive, a floppy drive, an optical disk drive, and a USB apparatus, or any combination thereof.

In the computer system, the non-volatile memory is coupled to the chipset via a low pin count (LPC) interface or a serial peripheral interface (SPI).

To sum up, in a computer system and a firmware recovery method for a computer system of the present invention, a display unit initial firmware may be read from a storage apparatus for initializing a display unit, so as to enable a user to recover the firmware by himself/herself according to a firmware recovery hint displayed on a display apparatus controlled by the display unit, thereby increasing convenience for the user to use the computer system.

In order to make the foregoing and other objectives, features, and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an architectural block diagram of a computer system according to an embodiment of the present invention.

FIG. 2 is a flow chart of processes of a firmware recovery method for a computer system according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

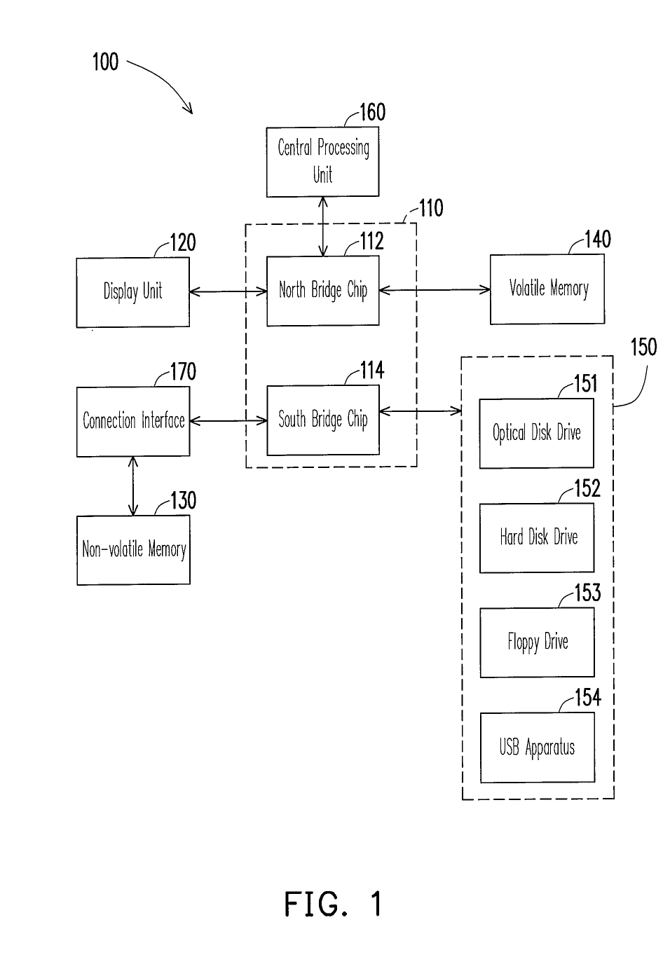

FIG. 1 is an architectural block diagram of a computer system according to an embodiment of the present invention. Referring to FIG. 1, a computer system 100 according to this embodiment includes a chipset 110, as well as a display unit 120, a non-volatile memory 130, a volatile memory 140 (commonly referred to as a main memory), a storage apparatus 150, and a central processing unit (CPU) 160 coupled to the chipset 110. In a system of different specification, the volatile memory 140 may be integrated into the CPU. After the computer system 100 is turned on, the CPU 160 determines whether a complete initial firmware of the computer system 100 is stored in the non-volatile memory 130. While not, the computer system 100 enters a firmware recovery mode.

The above chipset 110 is, for example, composed of a north bridge chip 112 and a south bridge chip 114. The north bridge chip 112 is respectively coupled to the CPU 160, the display unit 120, and the volatile memory 140. The south bridge chip 114 is coupled to the north bridge chip 112, the non-volatile memory 130, and the storage apparatus 150. The display unit 120 may include a video graph array (VGA) display unit integrated on a motherboard of the computer system 100, or a combination of a display card and a display, configured to display computer-related information on the display unit 120.

The non-volatile memory 130 may be a flash memory, and may be, for example, composed of an electrically erasable memory, a read only memory, or other non-volatile memories. It is characterized in that data is still stored in the non-volatile memory 130 after a power supply for the non-volatile memory 130 is turned off, which is different from the volatile memory 140 in which data is completely lost after the power supply is turned off. Therefore, the non-volatile memory 130 can more safely store the initial firmware of the whole computer system 100. The firmware described herein typically includes a basic input output system (BIOS). The non-volatile memory 130 may be coupled to the chipset 110 via a connection interface 170. The connection interface 170 is, for example, a low pin count (LPC) interface, a serial peripheral interface (SPI), or a connection interface of another form.

However, the non-volatile memory 130 includes a read only memory portion (not shown) for storing basic data, and an electrically erasable memory portion (not shown), for example, for storing a display unit (card) initial firmware which occupies a large memory space. The electrically erasable memory portion can be read/written, and is generally used in firmware update settings performed in cases of being connected to different peripheral components. However, when the firmware update is performed, most data in the electrically erasable memory portion will be lost, while the update fails due to external factors such as improper operations or power off. For example, no complete or no display unit (card) initial firmware can be found, and thus a current state cannot be notified to the user by the display unit. Therefore, a control program is internally designed in the present invention. While it is determined that the initial firmware in the non-volatile memory 130 is incomplete, enter a firmware recovery mode. First, a display unit initial firmware is obtained either from the non-volatile memory 130 or the storage apparatus 150. As soon as the display unit can provide a firmware recovery hint, further select to read a complete initial firmware from the storage apparatus 150 and then store the complete initial firmware in the non-volatile memory.

The storage apparatus 150 according to this embodiment includes any one selected from among an optical disk drive 151, a hard disk drive 152, a floppy drive 153, and a universal serial bus (USB) apparatus 154, or any combination thereof. It should be understood that the storage apparatus 150 may also include storage apparatus of other types.

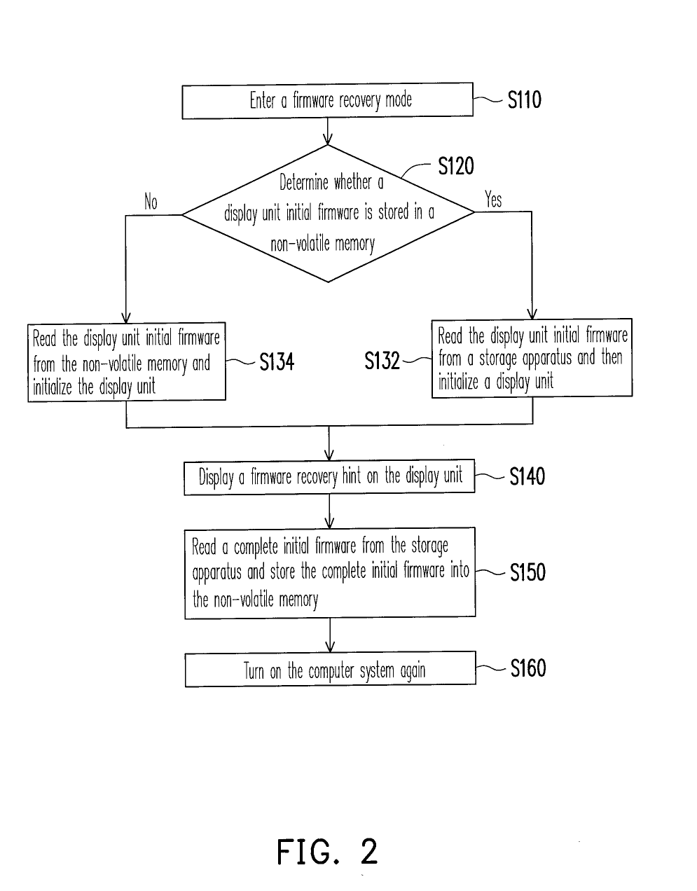

FIG. 2 is a flow chart of processes of a firmware recovery method for a computer system according to an embodiment of the present invention. Referring to FIG. 1 and FIG. 2, first, after the computer system 100 is turned on, the CPU 160 determines whether the complete initial firmware of the computer system 100 is stored in the non-volatile memory 130. While a previous firmware update fails due to an error occurred on the computer system 100 during the update process, the initial firmware in the non-volatile memory 130 is typically destroyed partially or completely. In this case, a firmware recovery work is required. Therefore, the computer system 100 enters a firmware recovery mode (Step S110).

Then, the CPU 160 determines whether a display unit initial firmware of the display unit 120 is stored in the non-volatile memory 130 of the computer system 100 via the chipset 110 (Step S120). While the display unit initial firmware of the display unit 120 is stored in the non-volatile memory 130, the display unit initial firmware of the display unit 120 is read from the non-volatile memory 130 for initializing the display unit 120 (Step S132). While the display unit initial firmware of the display unit 120 is not completely stored in the non-volatile memory 130, it is determined whether the display unit initial firmware of the display unit 120 is stored in the storage apparatus 150, and while it is determined that the display unit initial firmware of the display unit 120 is stored in the storage apparatus 150, the display unit initial firmware of the display unit 120 is read for initializing the display unit 120 (Step S134). The display unit initial firmware of the display unit 120 may be previously stored in the storage apparatus 150 such as a hard disk drive. Alternatively, when the user knows that a firmware recovery is to be performed, that is, before determining whether the display unit initial firmware of the display unit 120 is stored in the storage apparatus 150, a storage medium storing the display unit initial firmware of the display unit 120 may be put into the storage apparatus 150 such as a floppy drive or an optical disk drive, or may be coupled to the chipset 110 via an interface such as a USB interface.

Afterward, a firmware recovery hint is displayed on the initialized display unit 120 (Step S140), only by which can the user provide instructions to the CPU 160 step by step according to the firmware recovery hint displayed on the display unit 120 as reference, or can the CPU 160 automatically perform without any instruction input by the user, so as to read a complete initial firmware of the computer system 100 from the storage apparatus 150 and then store the complete initial firmware into the non-volatile memory 130 (Step S150).

The complete initial firmware of the computer system 100 and the display unit initial firmware of the display unit 120 used in Step S132 may be stored in one component or in different components in the storage apparatus 150. For example, but not limited to, they are stored in an optical disk drive, or respectively stored in an optical disk drive and a USB apparatus. The complete initial firmware of the computer system 100 refers to an initial firmware capable of initializing all components required for normal operation of the computer system 100. The complete initial firmware stored in the storage apparatus 150 is generally compiled into an image file first. In addition, when the complete initial firmware of the computer system 100 is read and stored into the non-volatile memory 130, the complete initial firmware of the computer system 100 may be read and stored into a volatile memory 140 first, and then stored into the non-volatile memory 130 from the volatile memory 140.

After Step S150 is finished, the computer system is turned on again (reset) (Step S160). Thus, the firmware recovery of the computer system 100 is finished.

To sum up, in a computer system and a firmware recovery method for a computer system of the present invention, a display unit initial firmware can be read from a storage apparatus for initializing a display unit, even though the display unit initial firmware is no longer stored in a non-volatile memory. Therefore, a user still can finish a firmware recovery work by himself/herself according to a firmware recovery hint displayed on a display apparatus controlled by the display unit without sending the computer system back to a manufacturer for maintenance, thereby improving convenience for the user to use the computer system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A firmware recovery method for a computer system, comprising:
entering a firmware recovery mode;
determining whether a display unit initial firmware is stored in a non-volatile memory;
reading the display unit initial firmware from a storage apparatus for initializing a display unit while the display unit initial firmware is not completely stored in the non-volatile memory;
displaying a firmware recovery hint on the display unit;
reading a complete initial firmware from the storage apparatus and then storing the complete initial firmware into the non-volatile memory; and
turning on the computer system again.

2. The firmware recovery method for a computer system according to claim 1, further comprising reading the display unit initial firmware from the non-volatile memory and initializing the display unit while the display unit initial firmware is stored in the non-volatile memory.

3. The firmware recovery method for a computer system according to claim 1, wherein the step of reading the display unit initial firmware from the storage apparatus comprises reading from a hard disk drive, a floppy drive, an optical disk drive, or a universal serial bus (USB) apparatus.

4. The firmware recovery method for a computer system according to claim 1, wherein the step of reading the complete initial firmware and then storing the complete initial firmware into the non-volatile memory comprises:
reading the complete initial firmware from the storage apparatus and then storing the complete initial firmware into a volatile memory; and
storing the complete initial firmware in the volatile memory into the non-volatile memory.

5. The firmware recovery method for a computer system according to claim 1, wherein the step of entering the firmware recovery mode comprises entering the firmware recovery mode only after determining that the complete initial firmware is not stored in the non-volatile memory.

6. The firmware recovery method for a computer system according to claim 1, wherein the step of reading the complete initial firmware from the storage apparatus comprises setting by a user according to the firmware recovery hint so as to read the complete initial firmware from the storage apparatus.

7. The firmware recovery method for a computer system according to claim 1, wherein the step of reading the display unit initial firmware from the storage apparatus comprises reading a storage medium in the storage apparatus.

8. A computer system, comprising:
a chipset;
a display unit, coupled to the chipset;
a non-volatile memory, coupled to the chipset;
a storage apparatus, coupled to the chipset; and
a central processing unit (CPU), coupled to the chipset, wherein while the CPU determines that a complete initial firmware is not stored in the non-volatile memory, the computer system enters a firmware recovery mode; while the CPU determines that a display unit initial firmware is not completely stored in the non-volatile memory, the display unit initial firmware is read from the storage apparatus for initializing the display unit, a firmware recovery hint is displayed on the display unit, the complete initial firmware of the storage apparatus is stored into the non-volatile memory, and the computer system is turned on again.

9. The computer system according to claim 8, wherein the chipset comprises:
a north bridge chip, coupled to the CPU and the display unit; and
a south bridge chip, coupled to the north bridge chip, the non-volatile memory, and the storage apparatus.

10. The computer system according to claim 8, wherein the display unit comprises a video graph array (VGA) display unit.

11. The computer system according to claim 8, wherein the non-volatile memory is a flash memory.

12. The computer system according to claim 8, wherein the non-volatile memory is composed of an electrically erasable memory and a read only memory.

13. The computer system according to claim 8, wherein the storage apparatus is any one selected from among a hard disk drive, a floppy drive, an optical disk drive, and a universal serial bus (USB) apparatus, or and any combination thereof.

14. The computer system according to claim 8, wherein the non-volatile memory is coupled to the chipset via a low pin count (LPC) interface or a serial peripheral interface (SPI).

15. The computer system according to claim 8, further comprising a volatile memory coupled to the chipset.
